(19) United States
(12) Patent Application Publication
(10) Pub. No.: US 2013/0321299 A1
(43) Pub. Date: Dec. 5, 2013

(54) ELECTRONIC DEVICE HAVING TACTILE DISPLAY USING SQUEEZE FILM EFFECT

(71) Applicant: KOREA INSTITUTE OF SCIENCE AND TECHNOLOGY, (US)

(72) Inventors: Keehoon Kim, Seoul (KR); Kwon Joong Son, Daejeon (KR)

(73) Assignee: KOREA INSTITUTE OF SCIENCE AND TECHNOLOGY, Seoul (KR)

(21) Appl. No.: 13/768,292

(22) Filed: Feb. 15, 2013

(30) Foreign Application Priority Data
May 31, 2012 (KR) 10-2012-0058209

(51) Int. Cl. G06F 3/041

(52) U.S. Cl. CPC G06F 3/041
USPC 345/173

(57) ABSTRACT

An electronic device has a touch screen, a protecting panel for protecting the touch screen by covering the touch screen, a vibration actuator coupled to the protecting panel to vibrate the protecting panel, and a control module for collecting location information of an input unit which touches the protecting panel, wherein the control module controls vibration characteristics of the vibration actuator according to a location of the input unit and forms a squeeze film between the input unit and the protecting panel to decrease a frictional force between the input unit and the protecting panel. The protecting panel has a visible area where the touch screen is exposed to be checked by the naked eyes, and an invisible area other than the visible area, and the vibration actuator is coupled to the invisible area.

### CROSS-REFERENCE TO RELATED APPLICATION

This application claims priority to Korean Patent Application No. 10-2012-0058209, filed on May 31, 2012, and all the benefits accruing therefrom under 35 U.S.C. §119, the contents of which in its entirety are herein incorporated by reference.

### BACKGROUND

1. Field

The present disclosure relates to an electronic device having a tactile display, and more particularly, to an electronic device having a tactile display using a squeeze film effect obtained by high-speed vibrations.

2. Description of the Related Art

Various electronic devices which operate according to direct contact of a user to a screen by using a touch screen are known in the art. Such electronic devices using a touch screen are used more and more since they may provide intuitive visual feedback to a user.

However, conventional electronic devices generally provide a visual interface, and in terms of feeling, they just give a haptic function which causes simple vibrations generated by a motor.

If various haptic feedbacks may be provided to a user according to various graphics displayed on a screen along with visual feedbacks, the user using such a device will take more satisfaction and such a device will be utilized in more fields.

### SUMMARY

The present disclosure is directed to providing an electronic device, which may implement a more realistic and useful user interface by providing a user with various haptic feedbacks as well as visual feedbacks by using a squeeze film effect.

In one aspect, there is provided an electronic device, which includes: a touch screen; a protecting panel for protecting the touch screen by covering the touch screen; a vibration actuator coupled to the protecting panel to vibrate the protecting panel; and a control module for collecting location information of an input unit which touches the protecting panel, wherein the control module controls vibration characteristics of the vibration actuator according to a location of the input unit and forms a squeeze film between the input unit and the protecting panel to decrease a frictional force between the input unit and the protecting panel.

According to an embodiment of the present disclosure, the protecting panel may include a visible area where the touch screen is exposed to be checked by the naked eyes, and an invisible area other than the visible area, and the vibration actuator may be coupled to the invisible area. The protecting panel may have an end fixed by a frame in which the touch screen is received, and the visible area may be formed at a center of the protecting panel, and the invisible area may be formed around the visible area.

The vibration actuator may be a piezoelectric unimorph actuator which includes: a metal layer coupled to the protecting panel; a piezoelectric element coupled to the metal layer; and a film electrode coupled to the piezoelectric element. According to an embodiment of the present disclosure, a plurality of piezoelectric elements may be coupled to a single metal layer, and the film electrode may be coupled to each piezoelectric element.

According to an embodiment of the present disclosure, the protecting panel may be a tempered glass, and the input unit may be a finger of a user.

According to an embodiment of the present disclosure, the control module may control frequency, phase difference and amplitude of an input voltage applied to the vibration actuator.

According to an embodiment of the present disclosure, the control module may operate the vibration actuator when the input unit is located on a dynamic graphic displayed on the touch screen. The dynamic graphic may be a button-type graphic operated by a tapping motion of the input unit or a movement-type graphic moving when the input unit performs a scrolling motion or a part of the movement-type graphic.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a diagram showing an electronic device according to an embodiment of the present disclosure;

FIG. 2 is a diagram for illustrating a motion equation of a thin rectangular panel made of isotropically linear elastic material under a fixed boundary condition;

FIG. 3 is a graph showing a difference in electromechanical coupling coefficient according to a location of a piezoelectric layer at a simple-support piezoelectric bimorph bar;

FIGS. 4A to 4C show various examples of the vibration actuator;

FIG. 5 is a conceptual diagram for illustrating operations of the electronic device according to an embodiment of the present disclosure;

FIG. 6 is a conceptual diagram showing an electronic device where four vibration actuators of FIG. 4B are arranged along the circumference of a protecting panel;

FIG. 7 shows a simulation result of stationary wave vibrations generated by the vibration actuator of the electronic device of FIG. 6; and

FIGS. 8A and 8B show application examples of the electronic device according to an embodiment of the present disclosure.

### DETAILED DESCRIPTION

Hereinafter, exemplary embodiments of the present disclosure will be described with reference to the accompanying drawings. Even though the present disclosure is described with reference to the embodiment shown in the drawings, it is just an example, and the technical spirit of the present disclosure and its essential components and operations are not limited thereto.

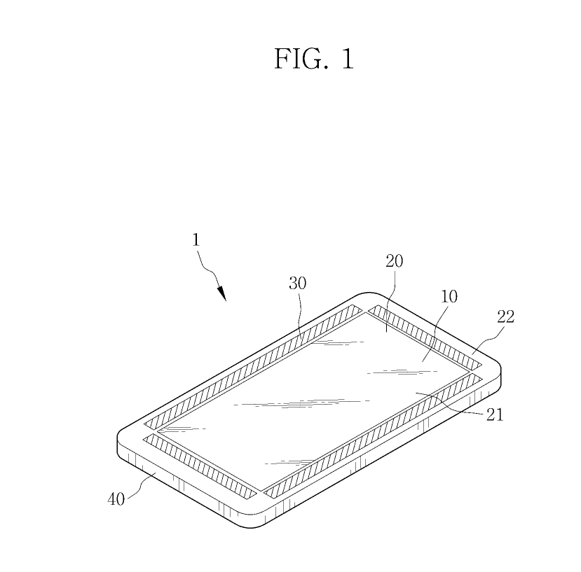

FIG. 1 shows a configuration of an electronic device 1 according to an embodiment of the present disclosure.

As shown in FIG. 1, the electronic device 1 of this embodiment includes a touch screen 10 and a protecting panel 20. The touch screen 10 is installed to be received in a rectangular frame 40. The protecting panel 20 has four edges fixed to the frame 40 and is installed to cover the touch screen 10 to play a role of protecting the touch screen 10 against external impacts. In this embodiment, the protecting panel 20 is made of a tempered glass.

The touch screen 10 is exposed out through a visible area 21 formed at the center of the protecting panel 20. A user may check the touch screen 10 by the naked eyes through the visible area 21, and various function keys displayed on the touch screen 10 may be operated by touching the touch screen 10 with an input unit such as a finger and a stylus. An invisible area 22 not exposing the touch screen 10 is formed around the visible area 21.

The configuration of the electronic device 1 described above is applied to known smart phones, tablet PC or the like, and not described in more detail here.

Reference symbol 30 represents a vibration actuator coupled to the protecting panel 20 to vibrate the protecting panel 20 in an ultrasonic band, as described in detail later.

The electronic device 1 of this embodiment gives a squeeze film effect generated between the protecting panel 20 and the finger used as the input unit, and provides a tactile display using a phenomenon that a frictional force decreases between the finger of the user and the protecting panel making a stationary wave vibration in the ultrasonic band.

The squeeze film effect means a vibration attenuation effect caused by the air collected between two interfaces which vibrate in the ultrasonic band, and it is known as reducing a friction force between the finger and the vibrating surface. Since the coefficient of friction between the finger and the article surface is a quantity relating to the texture of the article, the electronic device having a tactile display may be implemented by controlling a spatial distribution of the coefficient of surface friction by utilizing the squeeze film effect.

Hereinafter, free vibration and forced vibration which should be understood for implementing a tactile display based on friction control as well as a piezoelectric vibration actuator used as an ultrasonic band vibration source will be described first, and then detailed configuration and applications of the electronic device 1 according to this embodiment will be described.

1. Vibration of a Thin Panel

Vibrations with small amplitudes may be analyzed and described by means of a linear vibration theory. A continuum has an infinite number of eigen mode shapes, and a normal state response according to the synchronized vibration may be represented as a linear combination of eigen mode shapes.

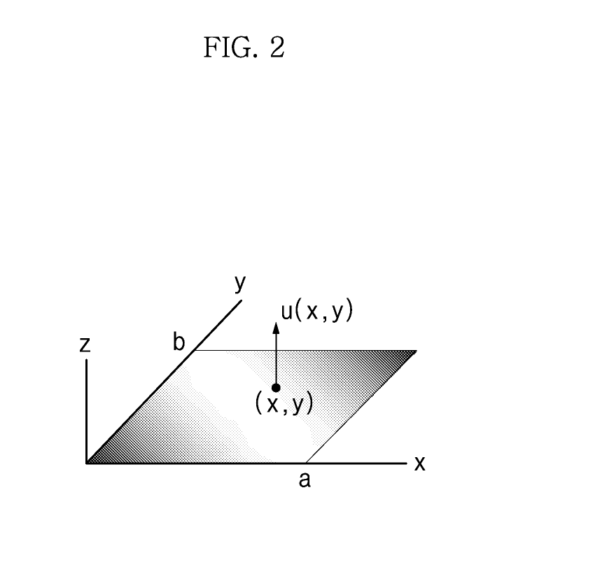

As shown in FIG. 2, a motion equation of a thin rectangular panel made of isotropically linear elastic material under a fixed boundary condition has a form of quartic partial differential equation, and its particular solution, a normal state response may be represented as a series form like Equation 1 below.

u(x,y)=Σₘ₌₁^{∞}Σₙ₌₁^{∞}AₘₙΦₘ(x)ψₙ(y) Equation 1

In case of a simple-support boundary condition which allows the degree of rotating freedom at four edges of the rectangular panel, the function of the eigen mode shapes is represented by Equation 2 below.

$${Φ}_{m} ( x ) = sin ( \frac{m π x}{a} ) \\ {Ψ}_{n} ( y ) = sin ( \frac{n π x}{b} ) \qquad Equation 2$$

Meanwhile, in case of a fixed support boundary condition which does not allow the degree of rotating freedom at four edges of the rectangular panel, the function of the eigen mode shapes is represented by Equation 3 below.

Φₘ(x)=Aₓ sin h(pₘx)+Bₓ cos h(pₘx)+Cₓ sin(pₘx)+Dₓ cos(pₘx)

ψₙ(y)=A_{y} sin h(pₙY)+B_{y} cos h(pₙy)+C_{y} sin(pₙy)+D_{y} cos(pₙy) Equation 3

Parameters pₘ, and pₙ used in the Equation 3 may be represented as eigen values corresponding to the (m, n) eigen mode shapes, and they may also be represented as dimension and properties of the rectangular panel and a degree of the eigen mode.

From Equations 2 and 3 showing the normal state response represented by the trigonometric function and the hyperbolic function, it may be understood that a nodal line with no amplitude is present on the vibrating rectangular panel. Since the squeeze film effect cannot be caused on the nodal line, it is impossible for a user to detect the frictional force reducing effect. Therefore, the distribution of nodal lines on the tactile display is a factor which determines the spatial distribution of coefficient of friction.

In order to simplify the problem of natural vibration, the vibration of a panel may also be described by using an approximate solution instead of a theory solution. As the approximate solution, there are frequently used a power series, a Fourier series, an index series or the like which are geometrically allowable, and this approximate method is called as a Ritz method. After expressing the normal state response in the form of an approximate solution by means of the Ritz method, coefficients of each term should be determined. In case of continuum vibration with an electromechanical coupling phenomenon, a governing equation is obtained by using Hamilton's principle. Then, after the approximate solution is put into the governing equation, coefficients of each term may be determined from the orthogonality of the function. By using the approximate solution obtained as above, a normal state response of a thin panel under forced vibration may be estimated.

2. Linear Piezoelectricity Constitutive Equation

A vibration actuator using a piezoelectric element is widely used as an ultrasonic wave actuator vibrator since it has a high resonant frequency of a vibrator and excellent energy conversion efficiency. The linear piezoelectricity constitutive equation based on the theory of linear piezoelectricity is represented by Equation 4 and Equation 5 below.

Sᵢ=sᵢⱼ^{E}Tⱼ+dᵢₖEₖ Equation 4

Dₖ=dᵢₖTₗ+∈ₖₗ^{T}Eₗ Equation 5

In Equations 4 and 5, S represents strain, T represents stress, E represents a magnetic field, D represents a electric flux density, Sᵢⱼ^{E} represents a short-circuit compliance matrix, dᵢₖ represents a piezoelectric strain tensor, and ∈ₖₗ^{T} represents a stress-free dielectric constant tensor. The superscript E used for the quantity represents a condition of E=0, and T represents a stress-free condition of T=0.

Regarding an index of each quantity, according to the Newton's summation convention, the stress and the strain are represented by a quadratic symmetric tensor or a linear tensor by Voigt notation. The relation between the Voigt notation and the tensor index is shown in Table 1 below.

TABLE 1

| | Voigt notation | | | | | |
|---|---|---|---|---|---|---|
| | 1 | 2 | 3 | 4 | 5 | 6 |
| tensor | xx | yy | zz | yz | xz | xy |
| index | (or 11) | (or 22) | (or 33) | (or 23) | (or 13) | (or 12) |

When analyzing a piezoelectric structure, a mechanical displacement or applied voltage is set as a boundary condition or input condition. At this time, since the quantity corresponds to strain and an electric field in the linear piezoelectricity constitutive equation, respectively, it is convenient to convert Equation 4 and Equation 5 into the form of Equation 6 and Equation 7 below.

Tᵢ=cᵢⱼ^{E}Sⱼ−eᵢₖEₖ Equation 6

Dₖ=cᵢₖSₗ+∈ₖₗ^{S}Eₗ Equation 7

Here Cᵢⱼ^{E} represents a short-circuit stiffness matrix, eᵢₖ represents a piezoelectirc stress tensor, and ∈ₖₗ^{S} represents a strain-free dielectric constant tensor. Generally, the panel-type piezoelectric ceramic material may be regarded as traverse isotropic material having a Z-axis in the thickness direction as a symmetric axis. The short-circuit stiffness matrix, piezoelectirc stress tensor, and strain-free dielectric constant tensor for the traverse isotropic material may be represented by matrixes of Equation 8 to Equation 10 below.

$$\begin{matrix}{c}_{ij}^{E} = {s}_{ij}^{{E}^{- 1}} = [ \begin{matrix}{c}_{11} & {c}_{12} & {c}_{13} & 0 & 0 & 0 \\ {c}_{12} & {c}_{11} & {c}_{12} & 0 & 0 & 0 \\ {c}_{13} & {c}_{13} & {c}_{13} & 0 & 0 & 0 \\ 0 & 0 & 0 & {c}_{55} & 0 & 0 \\ 0 & 0 & 0 & 0 & {c}_{55} & 0 \\ 0 & 0 & 0 & 0 & 0 & {c}_{55}\end{matrix} ] & Equation 8 \\ {c}_{ik} = {c}_{ij}^{E} {d}_{jk} = [ \begin{matrix}0 & 0 & {c}_{13} \\ 0 & 0 & {e}_{13} \\ 0 & 0 & {e}_{33} \\ 0 & {e}_{15} & 0 \\ {e}_{15} & 0 & 0 \\ 0 & 0 & 0\end{matrix} ] & Equation 9 \\ {ɛ}_{kl}^{S} = {ɛ}_{kl}^{T} - {d}_{ki}^{′} {c}_{ij}^{E} {d}_{jl} = [ \begin{matrix}{ɛ}_{11}^{T} & 0 & 0 \\ 0 & {ɛ}_{11}^{T} & 0 \\ 0 & 0 & {ɛ}_{33}^{T}\end{matrix} ] & Equation 10\end{matrix}$$

In Equation 10, the prime symbol (′) represents a transposed matrix.

3. Piezoelectric Vibration Actuator

The piezoelectric vibration actuator using an inverse piezoelectric effect, where a mechanical deformation is generated when an electric field is applied to piezoelectric material, ensures good energy efficiency and allows precise control to the level of nanometer. The piezoelectric vibration actuator has a relatively small mechanical displacement and thus may demand a structural design for amplifying the displacement.

In order to amplify a displacement, it is possible to configure a laminated piezoelectric vibration actuator by stacking thin panel-type piezoelectric elements into several layers or to amplify a displacement by attaching the piezoelectric element to a metal layer serving as a driven layer and thus causing a bending vibration.

The tactile display of this embodiment uses the bending vibration and excites at a resonance frequency to maximize the amplification of displacement. A structure where piezoelectric layers are attached to both surfaces of a driven layer to cause the bending vibration is called a piezoelectric bimorph actuator, and a structure using a single piezoelectric layer is called a piezoelectric unimorph actuator.

In the tactile display using a squeeze film effect, the following characteristics of the piezoelectric vibration actuator using a bending mode should be generally considered.

(1) As the driven metal layer has a lower density and a higher modulus of elasticity, the resonance frequency of the piezoelectric actuator increases (Feature 1).

(2) As the driven metal layer has an increased thickness, the area density increases, the inertial mass increases, the second moment of the cross-section increases, and the flexural rigidity also increases. At this time, since the inertial mass is in direct proportion to the cube of the thickness, when the thickness increases, the flexural rigidity increases greater in comparison to the increase of the inertial mass. Therefore, the resonant frequency increases (Feature 2).

(3) If the longitudinal size increases under the condition where the driven metal layer has a fixed thickness, the mass of the panel increases as a whole and simultaneously the flexural rigidity decreases. Therefore, the resonant frequency decreases. In particular, as the driven layer has a greater area, the wavelength corresponding to the stationary wave eigen mode increases, and so the gap between nodes increase (Feature 3).

(4) In case where the size of the piezoelectric element is smaller than the metal driven layer, the attachment location of the piezoelectric element gives an influence on the vibration characteristic of the piezoelectric actuator. In case where the piezoelectric layer is located near a loop of the stationary wave, the acceleration is greater than the case where the piezoelectric layer is located at a node, and so the inertia effect increases and the resonance frequency is lowered. If the piezoelectric layer is located near the fixed support boundary, when the piezoelectric layer vibrates, the inertia effect has an increased rigidity against bending, and as a result the resonance frequency increases (Feature 4).

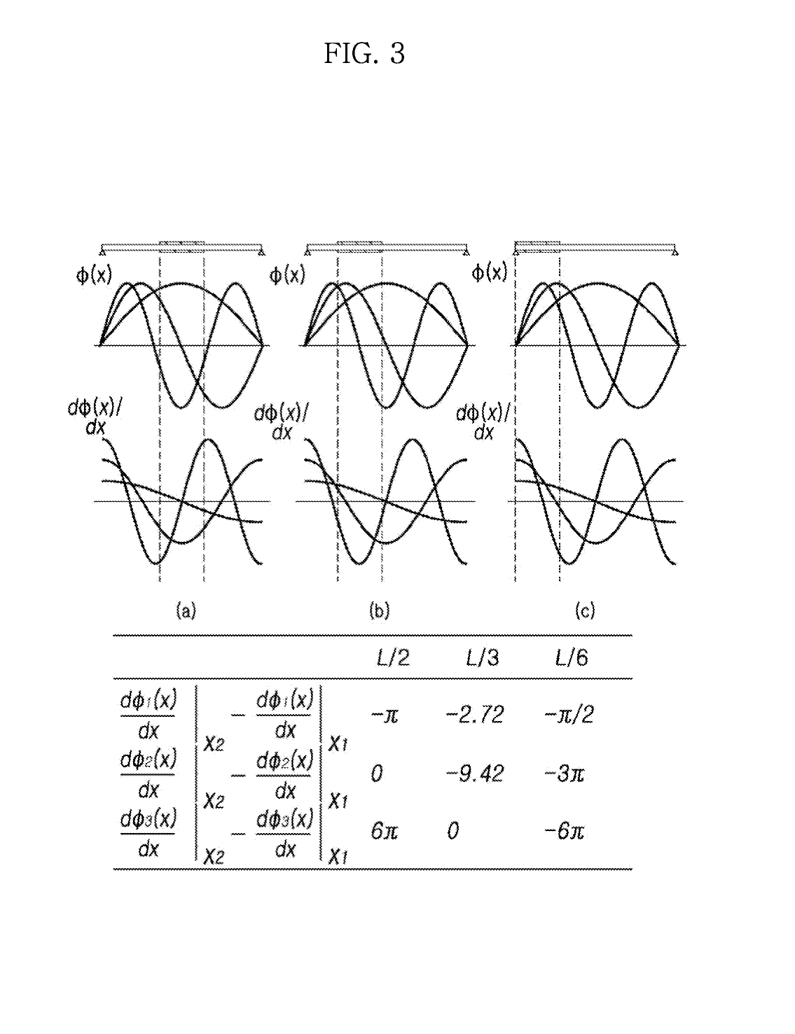

(5) A displacement gradient Vu of the piezoelectric layer performing a bending vibration and an electromechanical coupling coefficient of the piezoelectric actuator, namely electromechanical energy conversion, have a close relation. FIG. 3 is a graph showing a difference in electromechanical coupling coefficient according to a location of the piezoelectric layer at the simple-support piezoelectric bimorph bar.

The piezoelectric bar is in proportion to the value of

$$[ \frac{d u}{d x} {{\vert}_{{x}_{2}} - \frac{d u}{d x} \vert}_{{x}_{1}} ] ,$$

as shown in FIG. 3 (Feature 5).

(6) The mechanical displacement of the piezoelectric unimorph actuator is in proportion to the intensity of the applied electric field (namely, the intensity of an applied voltage) (Feature 6).

The tactile display using a squeeze film effect should utilize the resonance mode in an ultrasonic band of 25 kHz or above, but due to [Feature 2] and [Feature 3], when a large-area glass pane with a small thickness is used, the squeeze film effect may not be given due to the low resonant frequency. In order to enhance the resonance frequency, material with high density, high modulus of elasticity and low coefficient of damping should be used for the driven layer and the piezoelectric material according to [Feature 1] to [Feature 3], and the driven layer may have a smaller area and a greater thickness.

As described later, in order to use the tactile display to be overlaid on a touch screen of an electronic device such as an existing smart phone, the size of the driven layer is determined according to the size of the touch screen, and so changing the dimension of the driven layer may be restricted.

In order to design the tactile display using a squeeze film effect, the location of the piezoelectric layer should be considered. The resonance frequency may be enhanced by locating the piezoelectric layer near the fixed end of the glass panel according to [Feature 4].

In FIG. 3, assuming that the driven metal layer is L, if the degree of electromechanical coupling with respect to the first and third vibration modes is quantitatively checked while changing the central location of the piezoelectric layer having a length of L/4 is changed in the way of x=L/2, L/3, L/6, it may be understood that the case of (a) of FIG. 3 has no electromechanical conversion for the second eigen mode and the case of (c) of FIG. 3 has no electromechanical conversion for the third eigen mode. In other words, it may be understood that the piezoelectric effect and the inverse piezoelectric effect with respect to a specific eigen mode may not be exhibited according to the shape and location of the piezoelectric layer.

4. Electronic Device Having a Tactile Display

Heretofore, the principle and theory of the tactile display using a squeeze film effect have been described. Hereinafter, based on the piezoelectric theory and the vibration theory, a configuration capable of causing a squeeze film effect to a thinner and wider panel will be described.

The electronic device having a tactile display which causes a squeeze film effect should satisfy safety of a user, compensation for low resonant frequency in case of adopting a protecting panel made of a large pane, and easy agglutination with the touch screen.

The electronic device 1 of this embodiment uses a piezoelectric unimorph actuator as an ultrasonic vibration actuator 30 used for causing a squeeze film effect to the glass protecting panel 20.

Referring to FIG. 1 again, four vibration actuators 30 are coupled to the protecting panel 20 inside the frame 40. In detail, the vibration actuators 30 are disposed along four ends of the protecting panel 20 fixed to the frame 40 (namely, disposed near the fixed ends of the protecting panel 20).

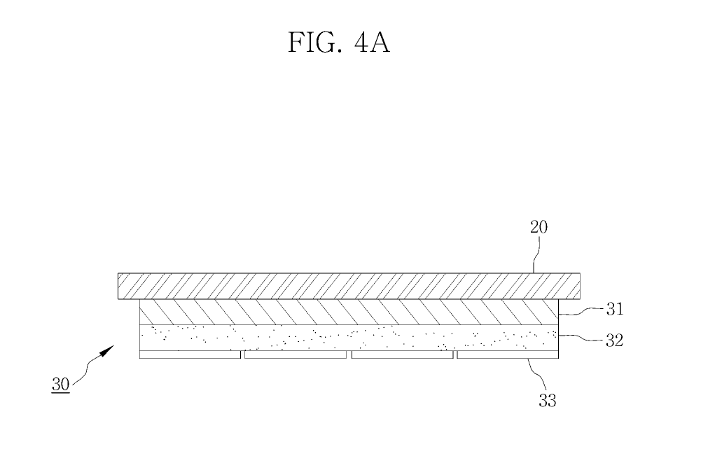

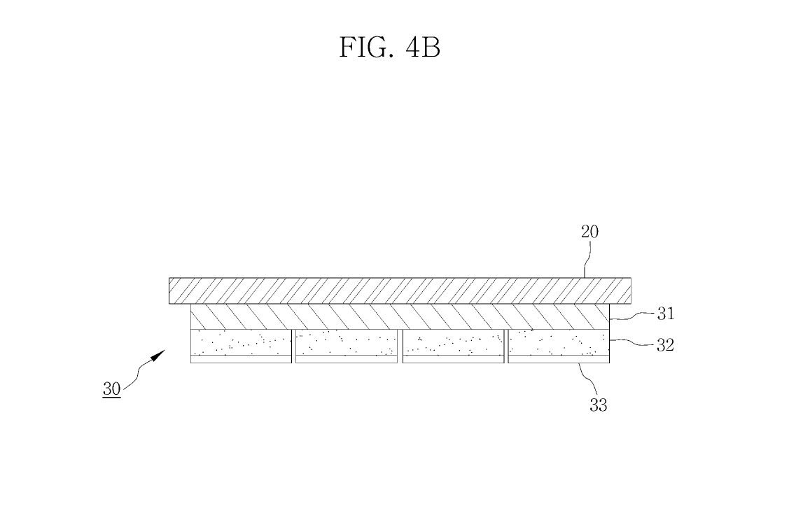

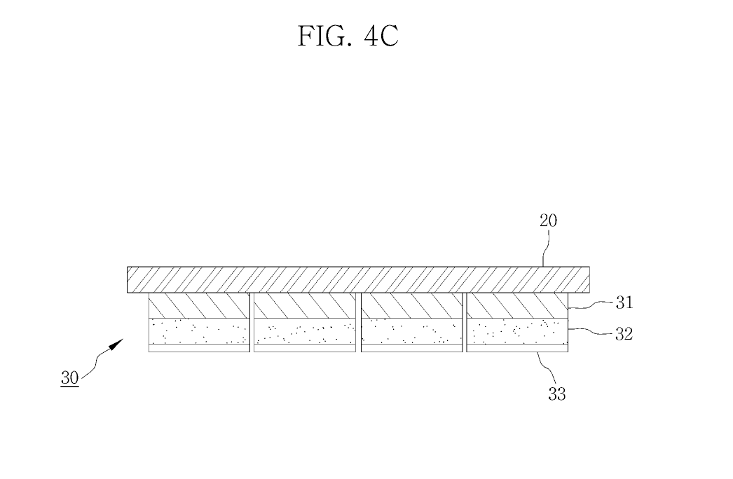

FIGS. 4A to 4C show various examples of the vibration actuator 30.

The vibration actuator 30 may be configured into three patterns: a structure where a plurality of film electrodes 33 is coupled on a single metal layer 31 and a single piezoelectric element layer 32 (FIG. 4A), a structure where a piezoelectric segment array including a plurality of piezoelectric elements 32 and film electrodes 33 respectively coupled thereto is coupled on a single metal layer 31 (FIG. 4B), and a structure where an actuator segment array including a plurality of metal layers 31, piezoelectric elements 32 and film electrodes 33 respectively coupled thereto is coupled on the protecting panel 20 (FIG. 4C).

When designing the vibration actuator 30, it should be considered that the electrode pattern and the piezoelectric array give an influence on the flexural rigidity and thus also give an influence on the vibration characteristics (resonance frequency, resonance mode) of the tactile display. In this embodiment, the vibration actuator 30 as shown in FIG. 4B is employed.

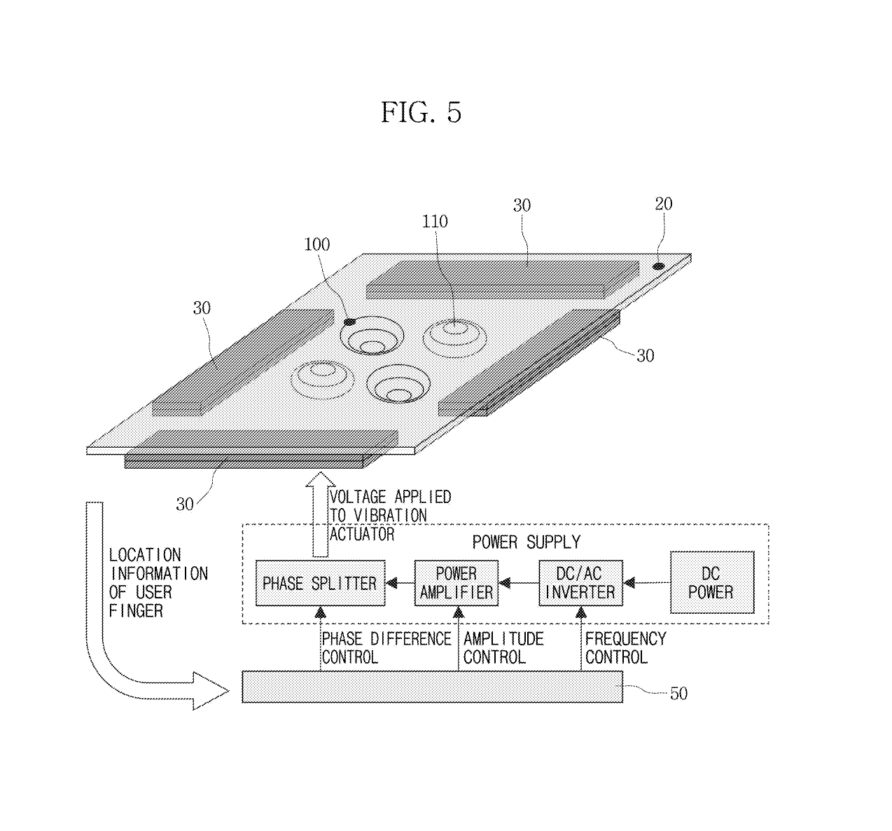

FIG. 5 is a conceptual diagram for illustrating operations of the electronic device 1 according to an embodiment of the present disclosure.

Referring to FIG. 5, the electronic device 1 of this embodiment includes a control module 50 for collecting location information of the finger of a user which is an input unit touching the protecting panel 20.

The control module 50 may generate a stationary wave vibration 100 which causes a squeeze film effect on the protecting panel 20 by controlling vibration characteristics of the vibration actuator 30. The stationary wave vibrations generated by independent vibrations of a plurality of vibration actuators cause interference with each other, and accordingly stationary waves are generated at a specific location of the protecting panel 20. As shown in FIG. 5, the generated stationary wave vibrations are symmetric and generally formed to have mountains and valleys repeatedly according to the polarities of the piezoelectric element of the vibration actuator.

At this time, the control module 50 may make various stationary wave patterns on the protecting panel 20 by controlling three voltage application conditions such as phase difference, amplitude and frequency of the vibration actuator 30 by using the vibration characteristics expressed by the above equations. Furthermore, according to this embodiment, the location of the finger of a user is collected, and it is controlled to generate a stationary wave vibration at the portion where the finger of the user touches.

For example, in case where the finger of the user is located at a position 110 as shown in FIG. 5, the control module 50 calculates phase difference, amplitude and frequency of each vibration actuator 30 in order to form a stationary wave vibration at the corresponding position. The calculated phase difference is converted through a phase splitter, and the amplitude is converted through a power amplifier, and the frequency is converted through a DC/AC inverter into a voltage to be applied to the vibration actuator, and the vibration actuator vibrates in correspondence to the characteristics of the applied voltage. Accordingly, a stationary wave vibration is generated at the position where the finger of the user is located to generate a squeeze film effect between the finger of the user and the protecting panel 20, and a frictional force between the finger and the protecting panel 20 decreases. At this time, as the vibration actuator has greater vibrating amplitude, the frictional force sensed by the user decreases more greatly.

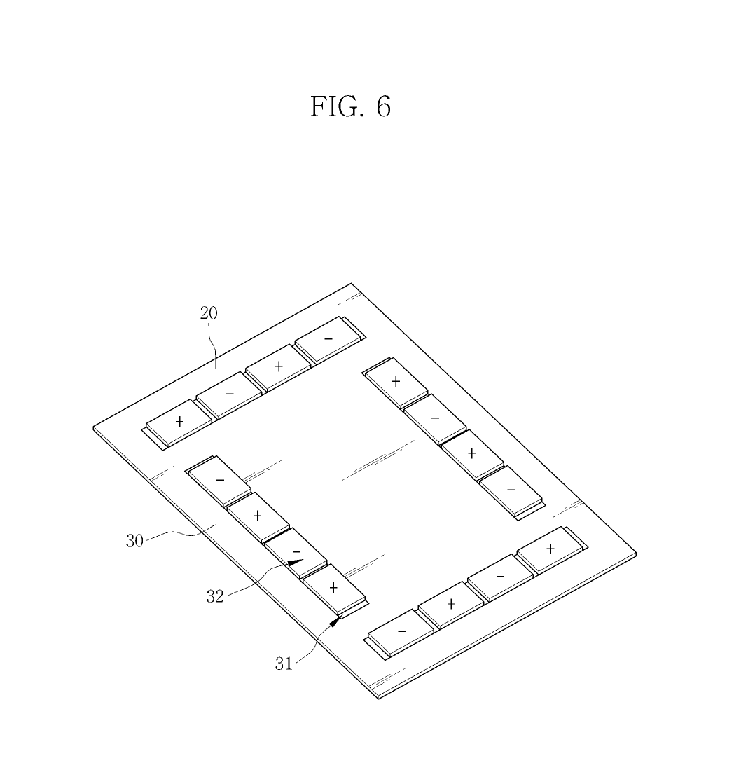

FIG. 6 is a conceptual diagram showing the electronic device 1 where four vibration actuators 30 of FIG. 4B are arranged along the circumference of the protecting panel 20.

Referring to FIG. 6, four vibration actuators 30 are disposed along the fixed ends of the protecting panel at the rear side of the protecting panel 20 which is a transparent glass pane. A metal layer 31 made of stainless steel and a piezoelectric element 32 made of PZT piezoelectric ceramic are attached to the vibration actuator 30. For convenience, the film electrode 33 is not shown in the figure.

As shown in FIG. 6, the vibration actuator 30 of this embodiment has a structure where four plate-type PZT ceramic layers are arranged in series with alternating polarities on a single metal layer made of stainless steel.

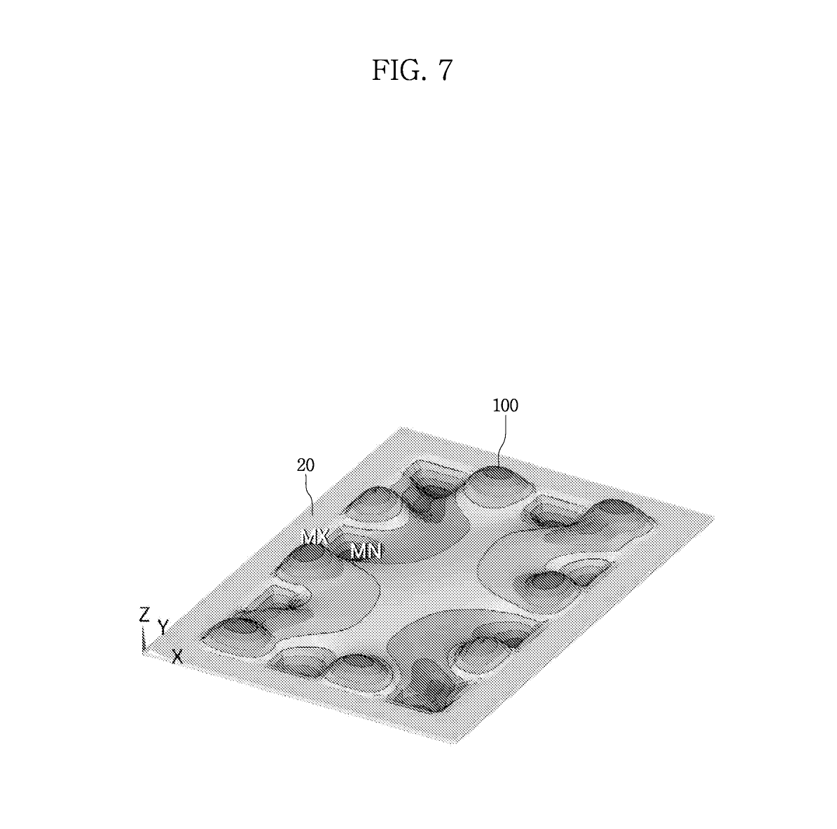

FIG. 7 shows a simulation result of a stationary wave vibration generated when a sine wave input voltage with a frequency of 20 kHz and amplitude of 50V is simultaneously applied to the vibration actuators 30 of the electronic device 1 of FIG. 6 (namely, when the input voltage is simultaneously applied to sixteen piezoelectric elements 32). It may be found that a stationary wave vibration 100 with 16 peaks formed by the piezoelectric elements 32 is generated on the protecting panel 20.

According to the electronic device 1 to which the tactile display configured as above is applied, a display of an existing smart phone or a tablet PC may be instantly remodeled into a tactile display by attaching the piezoelectric vibration actuators to a reinforcing panel for reinforcing the touch screen. Therefore, when adding a haptic function to an existing touch screen system, a serious design change is not demanded.

In addition, since the piezoelectric vibration actuators are located near the fixed ends of the protecting panel, the resonant frequency of the tactile display may be enhanced without deteriorating the visible area of the screen.

Furthermore, since the flexural rigidity increases due to the metallic driven layer between the glass panel and the piezoelectric layer, the resonant frequency of the display is enhanced, and so the deterioration of resonance frequency caused by the use of a thin glass panel may be compensated by inserting the metallic driven layer.

In addition, since the inserted metal layer may be used as an electric ground, a separate electrode is not specially required.

5. Application of the Tactile Display

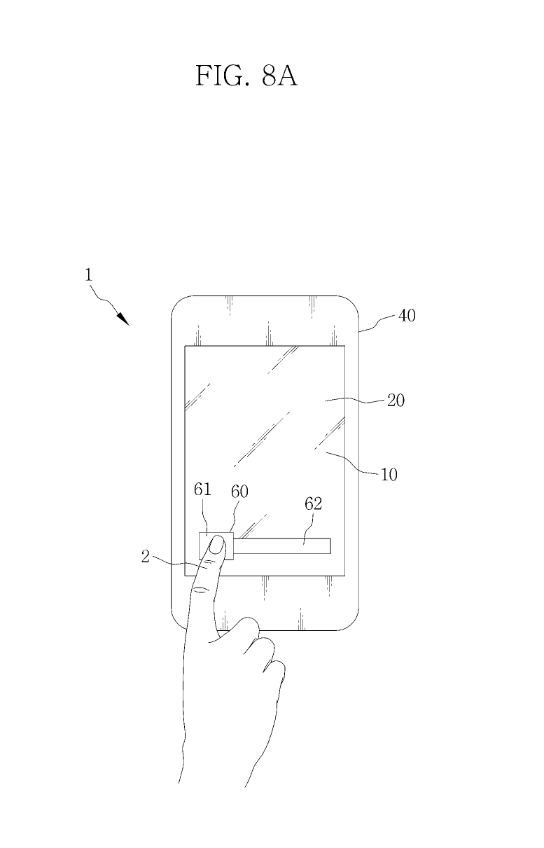

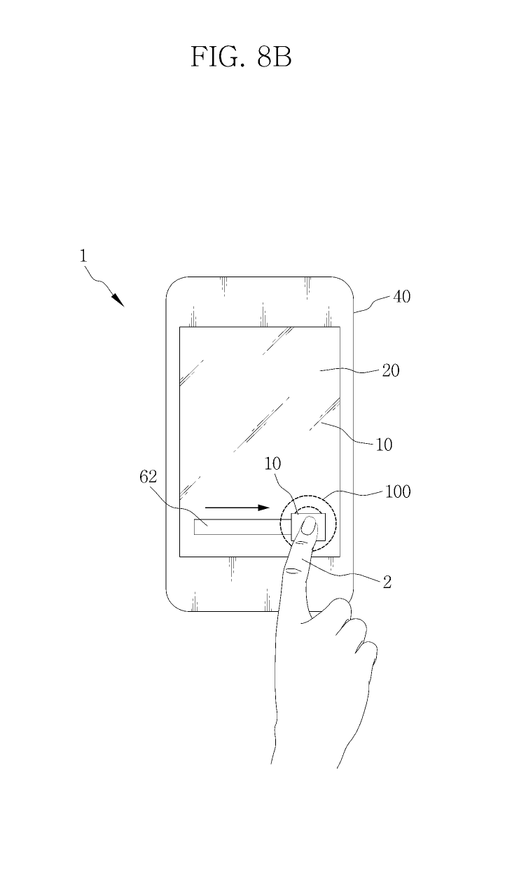

FIGS. 8A and 8B show application examples of the electronic device according to an embodiment of the present disclosure.

A screen of a smart phone or a navigation device displays various dynamic graphics. Here, the term “dynamic graphic” means a graph whose shape or location changes according to a contact made by the finger of a user.

For example, a button-type graphic which causes an execution of a function by a tapping motion of the user and a movement-type graphic which causes a movement corresponding to a scrolling motion of the user along a specific path may be regarded as the dynamic graphic.

According to this embodiment, a control module (not shown) operates the vibration actuator and generates a squeeze film effect when the finger of the user is located on a dynamic contents displayed on the touch screen.

FIGS. 8A and 8B show a movement-type graphic 60 which allows an execution of a specific function when the user moves a moving body 61 along a path 62 while contacting the moving body 61 by the finger.

At the start location of FIG. 8A, the user touches the moving body 61 by the finger 2 (the user should touch the protecting panel 20 and the graphic should be displayed on the touch screen 10), and in this state, the user moves the moving body 61 to the right on the figure. At this time, since the protecting panel 20 is made of glass, the user feels a predetermined frictional force on his finger.

If the finger of the user is located at the approval location of FIG. 8B, the control module (not shown) operates the vibration actuator (not shown) to generate a stationary wave vibration at the position where the finger of the user is located, thereby causing a squeeze film effect.

Accordingly, the frictional force between the finger of the user and the protecting panel 20 rapidly decreases, and the user feels as if the finger is released or separated from the protecting panel 20. Therefore, the user intuitively knows through the tactile feeling that he completely performs a specific operation.

In addition, in case where the dynamic graphic is a graphic having an acceleration motion frequently used for various games, when the user makes a scrolling motion on the protecting panel 20 by rubbing his finger, the frictional force between the finger and the protecting panel 20 may gradually decrease corresponding to the acceleration motion of the graphs, so that the user may feel the acceleration of the scrolled graphic not only visually but also tactually.

Moreover, if the user moves his finger to a location where a button-type graphic is located while rubbing near the location where the button-type graphic is located, a squeeze film effect may be generated at the corresponding location to decrease a frictional force at the corresponding location. In this case, since the frictional force of the button-type graphic is smaller than that of the surroundings, the user feels as if the button protrudes convexly. Therefore, in an electronic device such as a vehicle navigation device where a driver may not easily fine manipulation buttons with the eyes while driving a vehicle, the user may easily find the manipulation buttons only by a tactile feeling.

While the exemplary embodiments have been shown and described, it will be understood by those skilled in the art that various changes in form and details may be made thereto without departing from the spirit and scope of the present disclosure as defined by the appended claims.

What is claimed is:

1. An electronic device, comprising:
a touch screen;
a protecting panel for protecting the touch screen by covering the touch screen;
a vibration actuator coupled to the protecting panel to vibrate the protecting panel; and
a control module for collecting location information of an input unit which touches the protecting panel,
wherein the control module controls vibration characteristics of the vibration actuator according to a location of the input unit and forms a squeeze film between the input unit and the protecting panel to decrease a frictional force between the input unit and the protecting panel.

2. The electronic device according to claim 1,
wherein the protecting panel includes a visible area where the touch screen is exposed to be checked by the naked eyes, and an invisible area other than the visible area, and
wherein the vibration actuator is coupled to the invisible area.

3. The electronic device according to claim 2,
wherein the protecting panel has an end fixed by a frame in which the touch screen is received, and
wherein the visible area is formed at a center of the protecting panel, and the invisible area is formed around the visible area.

4. The electronic device according to claim 1, wherein the vibration actuator is a piezoelectric unimorph actuator including:
a metal layer coupled to the protecting panel;
a piezoelectric element coupled to the metal layer; and
a film electrode coupled to the piezoelectric element.

5. The electronic device according to claim 4,
wherein a plurality of piezoelectric elements is coupled to a single metal layer, and
wherein the film electrode is coupled to each piezoelectric element.

6. The electronic device according to claim 1, wherein the protecting panel is a tempered glass.

7. The electronic device according to claim 1, wherein the input unit is a finger of a user.

8. The electronic device according to claim 1, wherein the control module controls frequency, phase difference and amplitude of an input voltage applied to the vibration actuator.

9. The electronic device according to claim 1, wherein the control module operates the vibration actuator when the input unit is located on a dynamic graphic displayed on the touch screen.

10. The electronic device according to claim 9, wherein the dynamic graphic is a button-type graphic operated by a tapping motion of the input unit.

11. The electronic device according to claim 9, wherein the dynamic graphic is a movement-type graphic moving when the input unit performs a scrolling motion or a part of the movement-type graphic.
